(19) United States
(12) Patent Application Publication
(10) Pub. No.: US 2024/0068912 A1
(43) Pub. Date: Feb. 29, 2024

(54) Tire bending sensor

(71) Applicant: Enervibe Ltd., Airport City (IL)

(72) Inventor: Dan Haronian, Efrat (IL)

(73) Assignee: Enervibe Ltd., Airport City (IL)

(21) Appl. No.: 17/709,430

(22) Filed: Mar. 31, 2022

(51) Int. Cl. G01M 17/02; B60C 23/06; G01B 7/04; G01B 11/04

(52) U.S. Cl. CPC G01M 17/027; B60C 23/064; G01B 7/046; G01B 11/043; B60C 2019/004

(57) ABSTRACT

A system for measuring the length of the contact patch of a tire mounted on a wheel of a vehicle while the vehicle is traveling that includes a chassis, a light source, a light sensor, a data transmission unit, and a processor. The chassis is attached to the inner side of the tire, and the light source, the light sensor, and the data transmitting unit are attached to the chassis in a way that when the light source illuminates at a specific spot on the inner side of the tire the returning light is detected by the light sensor and the intensity of the returning light can be changed when that specific spot enters the contact patch and when exits the contact patch. The data transmitting unit calculates the length of the contact patch based on intensity changes of the detected light.

### TECHNICAL FIELD

The present invention refers to a system and a method of a real time vehicle tire bending sensor.

### BACKGROUND OF THE INVENTION AND PRIOR ART

The present invention describes a system and a method of an optical tire bending sensor. The sensor can be used to evaluate the patch length of a tire and the vibrations of the tire. These measurements may be used to estimate the load on a tire and the overall load on a vehicle equipped by such a sensor in at least one of its tires. Different vibration modes may also be used to estimate the tire vibrational modes and the road condition. The sensor may sense load shifting during driving and to alert from damage to the vehicle or the load and of potential accidents. Such a sensor may also be used to control the tire pressure using Automatic tire inflation systems (ATIS).

Patent publication number EP 2 832 561 B1, describes to a tire load sensing system of a vehicle comprising a distance sensor mounted on the vehicle adjacent to a corresponding tire that provides the distance between the sensor to a surface. Taking account of the tire pressure this information is analyzed to determines the tire load on the tire.

Patent publication number U.S. Pat. No. 8,096,174 B2 describes a tire load sensor that is computed from the dynamic rolling radius of a tire and the internal air pressure of the tire.

Patent publication number JP4165320B2, describes a tire condition detection device that uses strain gauges (2001, 2002) embedded inside the tire as described in FIG. 1a.

Patent publication number EP2085253B1 describes a tires with a sensor and methods for measuring tire strain using strain gauges (2003) fixed to the inner side of the tire as described in FIG. 1b. The method and sensor are used for measuring vibration or deformation of the tire and disposed on a surface portion of the tire.

Patent publication number U.S. Pat. No. 7,546,764B2 uses a strain sensor for measuring the deformation amount of a tire rubber portion on the inner side of the tread such as the above inner liner portion is installed on the inner liner portion to measure the above deformation amount, thereby making it possible to detect information on the contact patch of the tire and portions before and after the contact patch accurately.

In addition, tire load sensing using an accelerometer is a known art. The accelerometer is mounted on the inner side of a tire such that when the wheel rotates the accelerometer sense the vibrations of the tire and may sense the contact point of the tire with the ground and the detachment point of the tire with ground and therefore allow calculating the contact length of the tire with the ground. The contact length is correlated with the tire pressure and the load and therefore, knowing the pressure it is possible to calculate the load on the tire.

The disadvantage of using a strain gauge or accelerometers is the fact that these sensors are strained directly or indirectly. A strain gauge is fixed to the tire or embedded inside the tire goes through bending and straining as the tire bends. This bending is the source of an electrical signal generated inside the strain gauge that is proportional to the tire bending. An accelerometer uses a seismic mass suspended by a spring. The vibration and bending of the tire cause the seismic mass to vibrate and the spring to go through a compressive and tensile stresses. The accelerometer may also be subject to high centrifugal acceleration that may cause the springs to bend beyond their elastic range. The lifetime of these devices is limited by the number of cycles they can withstand and are limited by a maximum allowed force.

In this invention a sensing device is used to measure the tire bending without going through actual bending. For example, such a sensing device may an optical sensor such as a light source such as a LED or Laser diode, and an optical receiver. This optical sensing device is designed such that light emitted by the light source is reflected back from the tire to the optical receiver such that changes in the received light are a measure of the tire bending. Another sensing device may be for example a magnet fixed to the tire and a magnetic sensor that senses changes in the magnet flux that are induced by the movement of the magnet that is fixed to the tire.

### BRIEF DESCRIPTION OF THE FIGURES

FIG. 1a describes a prior art of a tire condition detection device.

FIG. 1b describes a tire with a strain gauges fixed to the inner side of the tire.

FIG. 2a depicts schematically a tire (1001) on a rim (1002) rolling over the ground (1003).

FIG. 2b is a schematic depiction of the signals.

FIGS. 3a, 3b and 3c describe the system (3) that is one embodiment of the invention,

FIG. 4a describes a recording of the light intensity that is sensed by system (3).

FIG. 4b is a Fast Fourier Transform (FFT) of the recording of FIG. 4a.

FIG. 5a depicts a close view of the tire with the system.

FIG. 5b is light intensity measurements sensed by the system.

FIGS. 6a, 6b, and 6c describe the system in different embodiment of the invention.

FIGS. 7 and 8 describe the system in another embodiment of the invention.

FIGS. 9a, 9b and 9c depict the system with a magnetic sensor (40) and a magnet (41).

FIGS. 10a, 10b and 10c depict the system (5) with an electromagnetic sensor (50).

FIG. 11 depicts the car 1000 with the system.

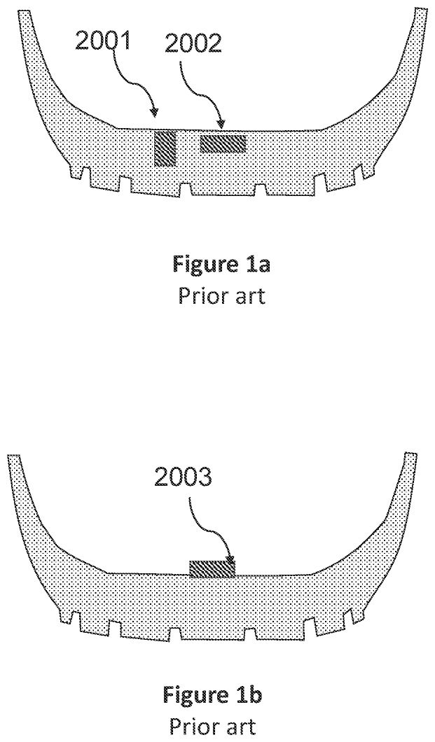

### FIELD OF THE INVENTION

The present invention discloses a method for a real time vehicle tire load sensing that is embedded inside the tire. The method comprises a mean to measure the tire patch length, a tire pressure sensor and an analyzer that relates the vehicle velocity, the tire patch length, and the tire pressure to the load on the tire.

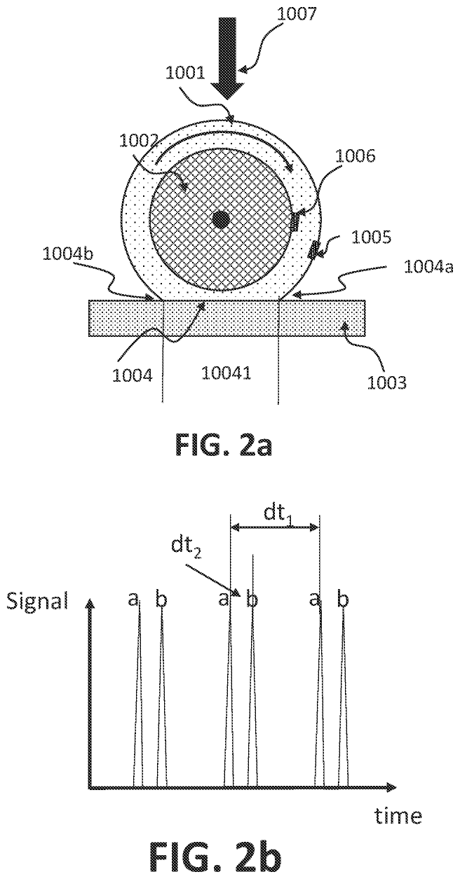

FIG. 2a describes schematically a tire (1001) on a rim (1002) rolling over the ground (1003). The patch is the area (1004) of contact between the tire and the ground. The length of the patch (10041) depends on the tire pressure as measured by a tire pressure sensor (1006) and the load on the tire (1007). The bending of the tire at point (1004a) is the entering point to the patch and the bending of the tire at point (1004b) is the exit point from the patch. In prior art a strain gauge (1005) that is fixed to the tire generates a signal at the entering and exiting points of the patch. This is described schematically in FIG. 2b by signals “a” and “b”. The time difference dt₁ is the time it takes for the wheel to complete a full rotation and dt₂ is the time it takes for the electromechanical device to cross the patch from point 1004a to point 1004b Therefore, assuming the circumference of the tire is L₁ the velocity of the vehicle is V=Lₜ/dt₁. In such case the patch length Lₚ=Vdt_{z}=L₁dt₂/dt₁=2pRdt₂/dt₁.

The load on the tire depends on the patch length, on the tire pressure and to some extend on the tire temperature, age, usage time and manufacturer. The load may be calculated either using for example an empirical equation, a lookup table or a machine learning software that considers different properties of the tire and of the environment.

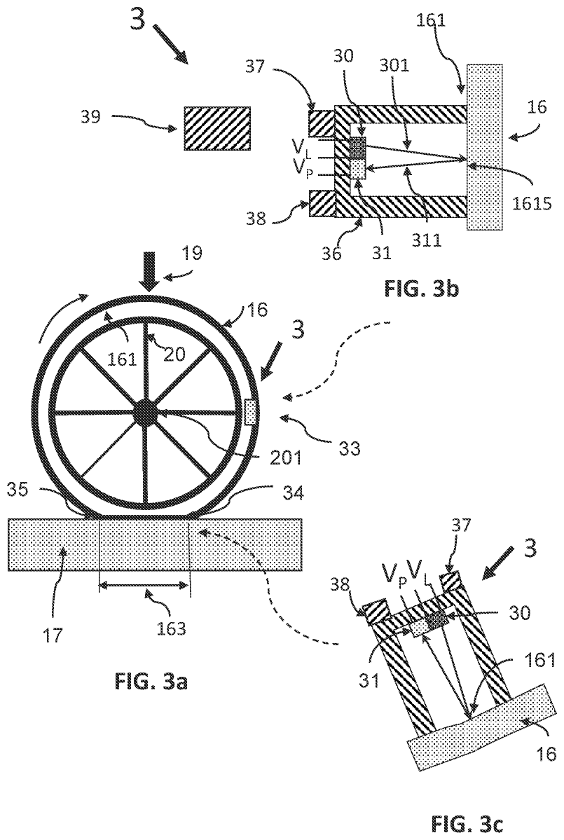

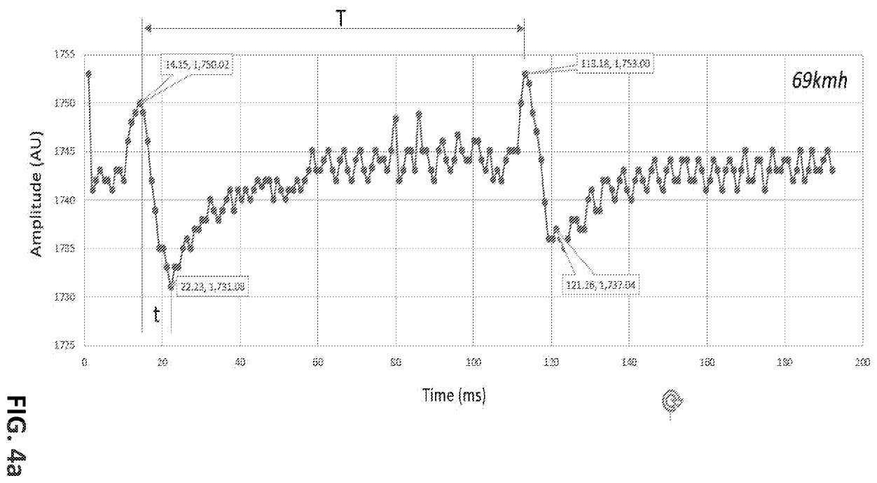

FIGS. 3a-3c describes one embodiment of this patent application. In this embodiment system (3) fixed to the inside of the tire comprises a light source (30), a light receiver (31), a transmitting unit (37), a power source (38) and processing unit (39). The light source, the light sensor the transmitter and the power source are mounted on a chassis (36) that is fixed to the inner side (161) of a tire (16). The power source (38) may be, for example, a battery or a kinetic energy harvester that converts mechanical energy into electricity. The processing unit may be mounted on chassis (36) or may be mounted outside of the tire. The power source powers the system and may be for example a battery or a kinetic energy harvester that converts mechanical energy into electrical energy. The light source and light sensor are mounted on the chassis such that light (301) emitted from light source (30) is reflected (311) from the surface of the tire at spot (1615) back to the light sensor. The tire is mounted on a wheel (20) and is in contact with the ground (17). The tire is loaded by weight (19) through the axle (201) forming a contact patch (163).

When the tire rotates spot (1615) reaches points (34) and (35) where the tire bends and the distance between the spot and the light source and light sensor changes which changes the intensity of the light that is sensed by the light sensor. The light sensor is designed to transmit to the processing unit signal as to the intensity of the light that the light sensor detects, and the processing unit is designed to calculate the length of the contact patch based on the changes in the intensity of the light detected by the light sensor. The calculated length of the patch can be used for calculating a load (19) on the tire, and a time difference between two successive entering the patch or two successive exiting the patch of the spot can be used for calculating a rotation rate of the wheel. The area where light is reflected from may be coated by a reflective material in order to enhance the intensity and change of the intensity of light that is collected by the light sensor.

The system may also sense bendings of the tire. The bendings of the tire may be in form of oscillating bending or constant bending. Oscillating bending may be generated from the vibration modes of the tire. The tire may be seen as a spring and such that when loaded by the load it has natural vibrational frequencies mode that depends on the tire properties and on the load. When the tire rotates, sporadic impacts cause the tire to vibrate at its natural frequency and the system may be used to calculate the load on the tire from measuring the natural vibration frequency of the tire. As the tire wears the tread depth of the tire becomes smaller and the weight of the tire decreases. Change in the tire weight will change the vibrational modes of the tire and the processor may alert of a worn-out tire by measuring the change in the natural frequency of the tire modes. The oscillating bending may also be due to road roughness or due to non-balanced tire and the processor may calculate the magnitude of road roughness or alert of a non-balanced tire.

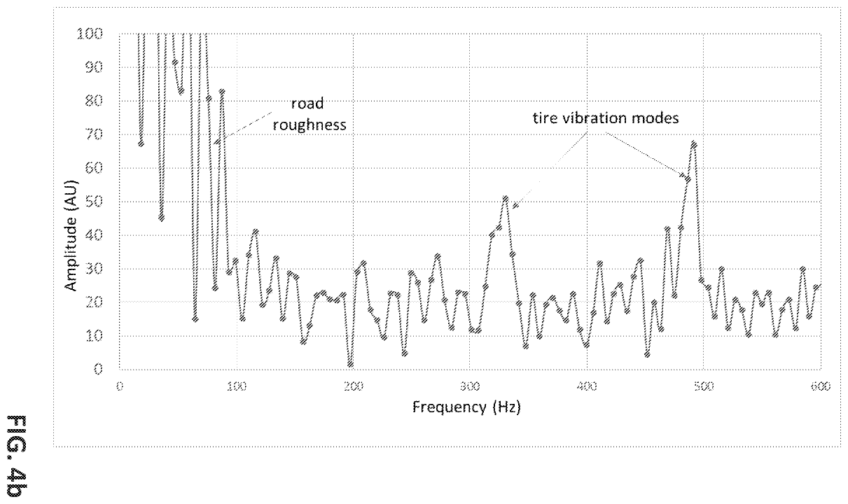

FIG. 4a describes a recording of the light intensity that is sensed by the optical sensor that is described in FIGS. 3a-3c. The time “T” is the time of one revolution and “t” is the time it takes the spot to cross the patch. FIG. 4b is the Fast Fourier Transform (FFT) of this recording in FIG. 4a showing the different vibrational modes of the tire. The tire vibrational modes are typically above 100 Hz while those of the road roughness are typically below 100 Hz. The time T repeats itself as the wheel rotates and therefore the rotation rate and vehicle speed may be also calculated from the FFT. The FFT may provide valuable information about the tire. For example, tire typically wear-out unevenly and therefore nonsymmetrical vibrational modes may appear in the FFT spectrum indicating wear-out of the tire. Aging of the tire may also lead to the appearance of new mode as the material composition of the tire is not even. Unbalanced tire will also generate new vibrational modes that can be detected. The FFT can teach about the road condition roughness and the load as well.

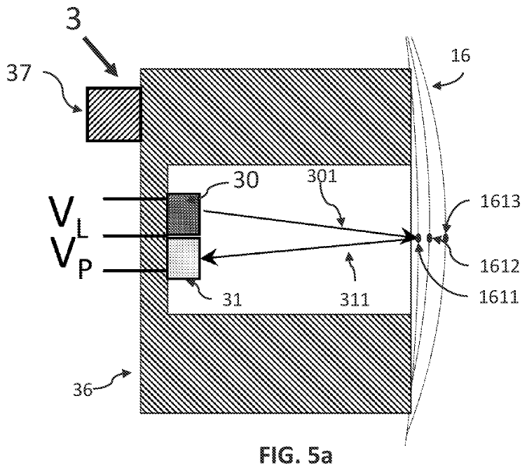

FIG. 5a describes a close view of the tire where the system is located with different loads. As the load increases the patch area increases as well, that expends the tire elsewhere radially. Therefore, different loads will result with different bending of the tire and therefore different intensity of light that is sensed by the optical sensor. In FIG. 5a points (1611), (1612), and (1613) describes schematically three radial expansions of the tire such that point (1611) represent the expansion of the tire with lower load than that of point (1612) and point (1612) represent the expansion of the tire with lower load that that of point (1613). The light intensity reflected back to the optical sensor from point (1611) is higher than that of point (1612) and the light intensity reflected back from point (1612) is higher than that of point (1613). This allows calculating the load even when the tire is not rolling.

FIG. 5b are measurements of the light intensity that is sensed by the optical sensor when different weights are applied on a static tire when the optical sensor is facing the patch and when it is off the patch. These results shows that different weight produce different optical signal since the bending of the tire is different under different loads. In addition, it shows that when the sensor faces the patch the intensity is higher for large load and smaller as the load decreases. On the other and off the patch area the order is reversed.

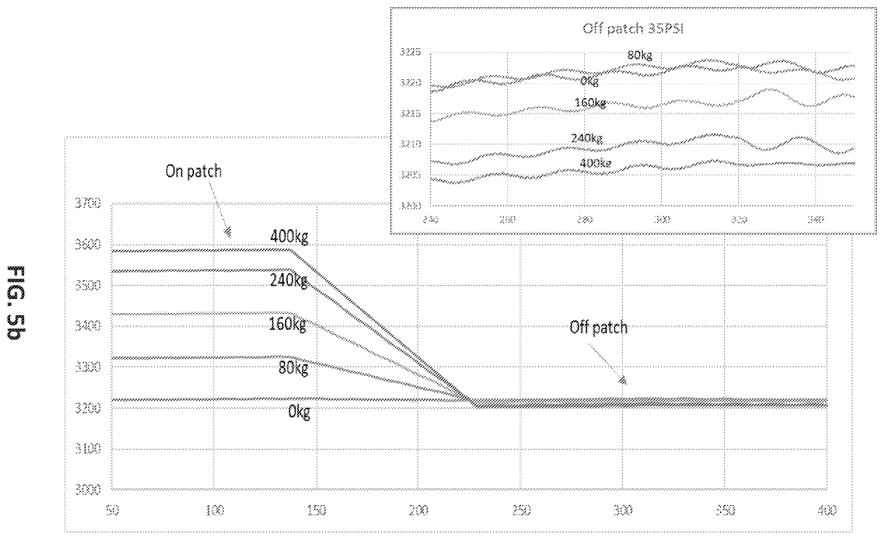

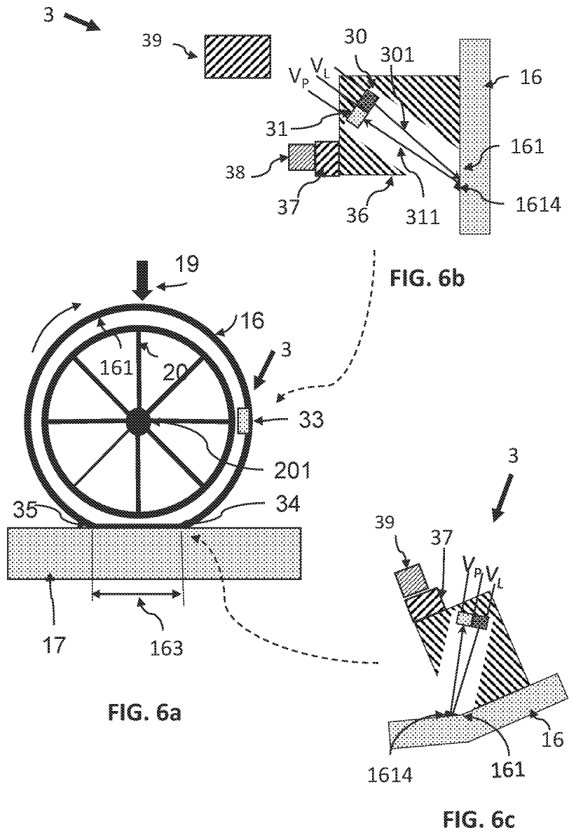

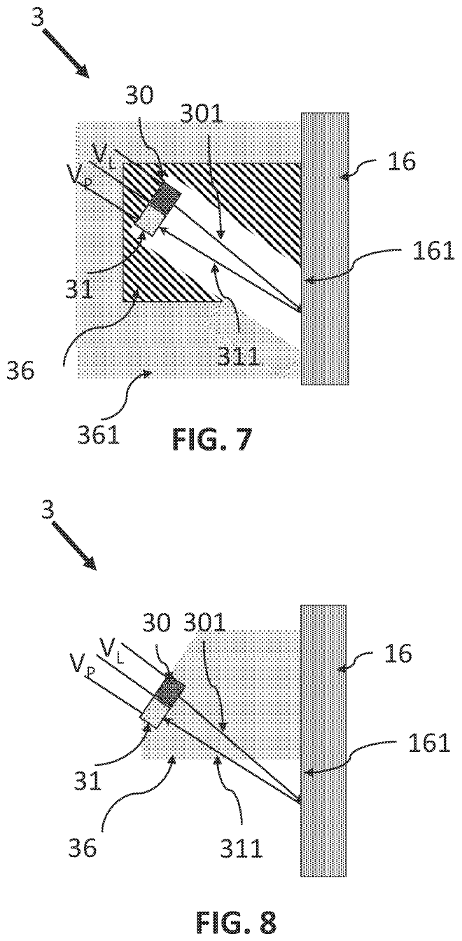

In FIGS. 3a-3c chassis (36) is rigid and therefore the bending of the tire is limited. Another option for the optical sensing device is shown in FIGS. 6a-6c. Here the light source and the light sensor are placed such that the light is reflected from the free part of the tire where the bending is more significant. In addition, a reflector (1614) may be formed on the tire that reflects the light back to the optical sensor FIG. 7 describes the system that is described in FIGS. 6a-6c with an addition of a flexible housing (361) for protecting the sensing device from contaminating the optical path. In addition, a light source with specific wavelength may be used that can go through the chassis such that the light source and the optical sensor are completely sealed as described in FIG. 8. For example, the optical wavelength of the light source (30) may be infrared, and the chassis (36) may be made of a clear polypropylene.

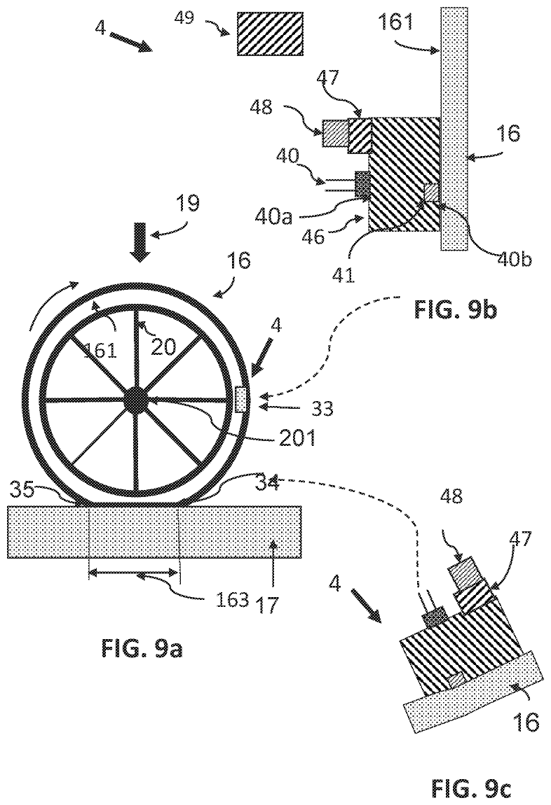

FIGS. 9a-9c describes another embodiment of this patent application. In this embodiment system (4) comprises a magnetic sensor (40) a magnet (41), a data transmitting unit (47) a power source (48) and a processor (49). The magnetic sensor and the transmitting unit are mounted on chassis (46) that is fixed to the inner side (161) of a tire (16). The magnet is fixed to the tire at close proximity to the magnetic sensor such that movement of the magnet may be sensed by the magnetic sensor. The power source (48) may be, for example, a battery or a kinetic energy harvester that converts mechanical energy into electricity. The processor (49) may be mounted on the chassis or may be fixed to the vehicle outside the tire. Magnet (41) may be a simple magnet in any preferred orientation or some combination of magnets such that the deformation of the tire results in a high change of the signal in the magnetic sensor.

The tire is mounted on a wheel (20) and is in contact with the ground (17). The tire is loaded by weight (19) through the axle (201) forming a contact patch (163). When the tire rotates the magnet reaches points (34) and (35) where the tire bends and the magnet change its orientation or position that change the magnetic field that is sensed by the magnetic sensor (40). The magnetic sensor is designed to transmit to the processing unit signal as to the intensity of the magnetic field that the magnetic field sensor detects and the processing unit is designed to calculate the length of the contact patch based on the changes in the intensity of the magnetic field detected by the magnetic field sensor. The calculated length of the patch can be used for calculating a load (19) on the tire, and a time difference between two successive entering to the patch or two successive exiting to the patch of the magnet can be used for calculating a rotation rate of the wheel.

The magnetic system described in FIGS. 9a-9c functions in similar to that of the optical system described in FIGS. 3a-3c. Both systems measure the bendings of the tire. Therefore, the system described in FIGS. 9a-9c may also be used to calculate the load on the tire from the tire, the road roughness the tire wear and balance and the rotation rate and vehicle speed, from the vibration spectrum of the tire the Magnet (41), described in FIGS. 9a-9c is shown embedded inside the chassis.

It is clear that this location is an example. The magnet may for example be fixed to the tire next to the chassis, or it may be fixed to the tire inside a cavity in the chassis.

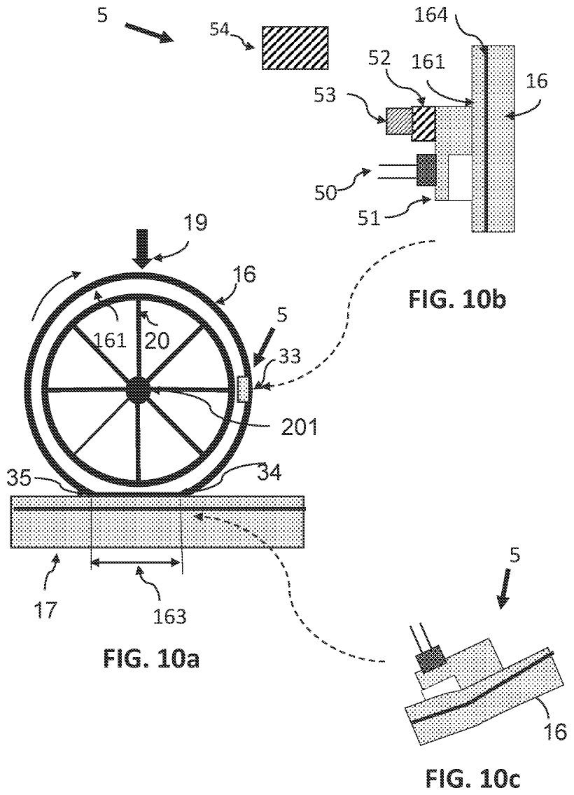

FIGS. 10a-10c shows another embodiment of this patent application. In this embodiment system (5) comprise an electromagnetic sensor (50), a transmitting unit (52) a power source (53) and a processor (54). The electromagnetic sensor and the transmitting unit are mounted on chassis (51). The power source (53) may be, for example, a battery or a kinetic energy harvester that converts mechanical energy into electricity. The processor (53) may be mounted on the chassis or on the vehicle outside of the tire. FIGS. 10a-10c also refers to steel mash (164) that reinforces the tire. The electromagnetic sensor (50) may comprise, for example, a coil such that movement of the steel mash, as a result of the tire bendings, changes the magnetic field in the coil and generates voltage drop between the two ends of the coil.

The tire is mounted on a wheel (20) and is in contact with the ground (17). The tire is loaded by weight (19) through the axle (201) forming a contact patch (163). When the tire rotates the steel mesh reaches points (34) and (35) where the tire deforms, and the steel mesh changes its distance to the electromagnetic sensor that change the magnetic field in the electromagnetic sensor and therefore changes the signal generated by the electromagnetic sensor. The electromagnetic sensor is designed to transmit to the processing unit the signals it generates, and the processing unit is designed to calculate the length of the contact patch based on the changes in the signal intensity of the magnetic field detected by the magnetic field sensor. The calculated length of the patch can be used for calculating a load (19) on the tire, and a time difference between two successive entering to the patch or two successive exiting to the patch of the magnet can be used for calculating a rotation rate of the wheel.

The magnetic system described in FIGS. 10a-10c functions in similar to that of the optical system described in FIGS. 3a-3c and in FIGS. 9a-9c. The three systems measure the bendings of the tire. Therefore, the systems described in FIGS. 9a-9c and in FIGS. 10a-10c may also be used to calculate the load on the tire, the road roughness the tire wear and balance and the rotation rate and vehicle speed, from the vibration spectrum of the tire.

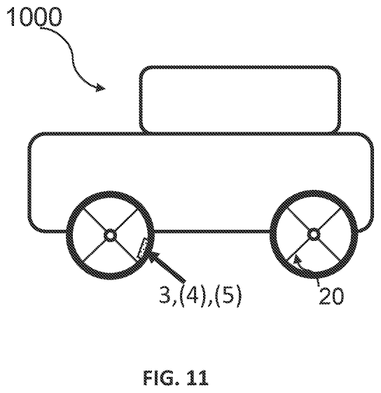

FIG. 11 depicts the car 1000 with the system. It is noted that the processing unit may be inside the tire, or it may be outside of the tire, for example as part of the vehicle computer system.

The present invention discloses a system (3) for measuring the length of the contact patch (163) of a tire (16) that is mounted on a wheel (20) of a vehicle (1000) while the vehicle is traveling. The system includes a chassis (36), a light source (31), a light sensor (30), a data transmission unit (37), a power source (38) for powering the system, and a processing unit (39). The chassis is designed to be attached to an inner side (161) of the tire. The light source, the light sensor, the data transmitting unit and the power source are attached to the chassis in such a way that when the light source illuminates at a specific spot (1615) on the inner side of the tire a returning light can be detected by the light sensor and in such a way that an intensity of the returning light can be changed when the specific spot enters the contact patch and when exits the contact patch. The light sensor is designed to transmit to the processing unit signal as to the intensity of the light that the light sensor detects. The data transmitting unit is designed to calculate the length of the contact patch based on changes in the intensity of the light detected by the light sensor. The calculated length of the patch can be used for calculating a load on the tire, and a time difference between successive entries or successive exits of the specific spot into or from the contact patch can be used for calculating the rotation rate of the wheel. The power source of the system (3) can be a battery, a rechargeable battery or an energy harvester that converts kinetic energy to electricity.

The present invention discloses also a system (4) for measuring a length of a contact patch (163) of a tire (16) mounted on a wheel (20) of a vehicle (1000) while the vehicle is traveling that includes a chassis (36), a magnet (41), a magnetic field sensor (40), a transmitting unit (47), a power source (48) for powering said system, and a processing unit (49). The magnetic field sensor is designed to be attached to a first spot (40a) relative to the magnet that is designed to be attached to a second spot (40b) on the inner side of the tire, in such a way that a magnetic field of the magnet can be detected by the magnetic field sensor such that an intensity of the detected magnetic field can be changed when the magnet enters the contact patch and when exits the contact patch. The magnetic field sensor is designed to transmit to the processing unit signal as to the intensity of the magnetic field that the magnetic field sensor detects. The data transmitting unit is designed to calculate the length of the contact patch based on the changes in the intensity of the magnetic field detected by the magnetic field sensor. The calculated length of the patch can be used for calculating a load on the tire, and a time difference between successive entries or exits of the magnet into or from the contact patch can be used for calculating a rotation rate of the wheel.

The present invention discloses a system (5) for measuring a length of a contact patch (163) of a tire (16) that is reinforced by a steel mesh (164) mounted on the wheel (20) of a vehicle (1000) while the vehicle is traveling. The system includes a chassis (36), an electromagnetic sensor (50), a data transmitting unit (52), a power source (53) for powering the system and a processing unit (54). The chassis is designed to be attached to an inner side (161) of the tire. The electromagnetic sensor is attached to the chassis in such a way that an intensity of a magnetic field at the electromagnetic sensor can be changed when the chassis enters the contact patch and when exists the contact patch as a result of changing a distance between the electromagnetic sensor to the steel mesh. The data transmitting unit is designed to transmit to the processing unit signal as to the changes of the intensity of the magnetic field. The processing unit is designed to calculate the length of the contact patch based on the changes of the intensity of the magnetic field of the electromagnetic sensor. Here too the calculated length of the patch can be used for calculating a load on the tire, and a time difference between entries or exits of the chassis into or from the contact patch can be used for calculating a rotation rate of the wheel.

The present invention discloses also the system (3) for measuring level of bendings of a tire (16) mounted on a wheel (20) of a vehicle (1000) that includes a chassis (36), a light source (31), a light sensor (30), a data transmission unit (37), a power source (38) for powering the system, and a processing unit (39). The chassis is designed to be attached to an inner side (161) of the tire. The light source, the light sensor, the data transmitting unit, and the power source are attached to the chassis in such a way that when the light source illuminates the inner side of the tire a returning light can be detected by the light sensor and in such a way that an intensity of the returning light can be changed due to changes of level of bendings of the tire. The data transmitting unit is designed to transmit to the processing unit signal as to the intensity of the light that the light sensor detects. The processing unit is designed to calculate the level of the bendings of the tire based on the changes in the intensity of the light detected by the light sensor. The calculated level of the bendings, as stated before, can be used for calculating the load on the tire, the rotation rate of the wheel, the road roughness, the tire alignment and the wear condition of the tire.

The present invention discloses a system (4) for measuring bendings of a tire (16) mounted on a wheel (20) of a vehicle (1000) that comprises a chassis (36), a magnet (41), a magnetic field sensor (40), a data transmission unit (47) a power source (48) for powering the system, and a processing unit (49). The magnetic field sensor is designed to be attached to a first spot (40a) relative to the magnet, on an inner side (161) of the tire and the magnet is designed to be attached to a second spot (40b) on the inner side of the tire, in such a way that a magnetic field of the magnet can be detected by the magnetic field sensor such that an intensity of the detected magnetic field can be changed due to bendings of the tire. The data transmitting unit is designed to transmit to the processing unit signal as to the intensity of the magnetic field that the magnetic field sensor detects. The processing unit is designed to calculate the bendings of the tire based on the changes in the intensity of the magnetic field detected by the magnetic field sensor. The calculated bendings can be used for calculating a load on the tire, a rotation rate of the wheel, a road roughness, a tire alignment, and a wear condition of the tire.

The present invention also discloses a system (5) for measuring the bendings of a tire (16) that is reinforced by a steel mesh (164) when the tire is mounted on a wheel (20) of a vehicle (1000). This system includes a chassis (36), an electromagnetic sensor (50), a data transmitting unit (52), a power source (53) for powering the system, and a processing unit (54). The chassis is designed to be attached to an inner side (161) of the tire. The electromagnetic sensor is attached to the chassis in such a way that the intensity of the magnetic field at the electromagnetic sensor can be changed due the bendings of the tire as a result of a change in the distance between the electromagnetic sensor to the steel mesh. The data transmitting unit (52) is designed to transmit to the processing unit signal as to the intensity of the magnetic field that the electromagnetic sensor detects. The processing unit is designed to calculate the bendings of the tire based on the changes of the intensity of the magnetic field of the electromagnetic sensor. The calculated bendings of the tire can be used for calculating a load on the tire, a rotation rate of the wheel, a road roughness, a tire alignment and a wear condition of the tire.

The present invention discloses a method for calculating a load on a tire (16) that is mounted on a wheel (20) of a vehicle (1000), for calculating a rotation rate of the wheel, for calculating a wear condition of the wheel, for calculating a road roughness on which the vehicle is traveling, or for calculating alignment of the tire, comprising the steps of measuring changes in bendings of the tire and using information as to said changes for processing the calculation.

What is claimed is:

1. A system for measuring a length of a contact patch of a tire mounted on a wheel of a vehicle while the vehicle is traveling that comprises a chassis, a light source, a light sensor, a data transmission unit, a power source for powering the system, and a processing unit; wherein the chassis is designed to be attached to an inner side of the tire; wherein said light source, said light sensor, said data transmitting unit and said power source are attached to the chassis in such a way that when the light source illuminates at a specific spot on the inner side of the tire a returning light can be detected by the light sensor and in such a way that an intensity of the returning light can be changed when the specific spot enters the contact patch and when exits the contact patch; wherein said light sensor is designed to transmit to the processing unit signal as to the intensity of the light that the light sensor detects; wherein the data transmitting unit is designed to calculate the length of the contact patch based on changes in the intensity of the light detected by the light sensor; and wherein the calculated length of the patch can be used for calculating a load on the tire, and a time difference between successive entries or successive exits of the specific spot into or from the contact patch can be used for calculating a rotation rate of the wheel.

2. The system for measuring a length of a contact patch of a tire mounted on a wheel of a vehicle while the vehicle is traveling according to claim 1, wherein said power source is a battery, a rechargeable battery or an energy harvester that converts kinetic energy to electricity.

3. A system for measuring a length of a contact patch of a tire mounted on a wheel of a vehicle while the vehicle is traveling comprises a chassis, a magnet, a magnetic field sensor, a transmitting unit, a power source for powering said system, and a processing unit; wherein said magnetic field sensor is designed to be attached to a first spot relative to said magnet that is designed to be attached to a second spot on the inner side of the tire, in such a way that a magnetic field of the magnet can be detected by the magnetic field sensor such that an intensity of the detected magnetic field can be changed when the magnet enters the contact patch and when exits the contact patch; wherein said magnetic field sensor is designed to transmit to the processing unit signal as to the intensity of the magnetic field that the magnetic field sensor detects; wherein the data transmitting unit is designed to calculate the length of the contact patch based on the changes in the intensity of the magnetic field detected by the magnetic field sensor; and wherein the calculated length of the patch can be used for calculating a load on the tire, and a time difference between successive entries or exits of the magnet into or from the contact patch can be used for calculating a rotation rate of the wheel.

4. The system for measuring a length of a contact patch of a tire mounted on a wheel of a vehicle while the vehicle is traveling according to claim 3, wherein said power source is a battery, a rechargeable battery or an energy harvester that converts kinetic energy to electricity.

5. A system for measuring a length of a contact patch of a tire that is reinforced by a steel mesh mounted on a wheel of a vehicle while the vehicle is traveling comprises a chassis, an electromagnetic sensor, a data transmitting unit, a power source for powering the system and a processing unit; wherein said chassis is designed to be attached to an inner side of the tire; wherein said electromagnetic sensor is attached to the chassis in such a way that an intensity of a magnetic field at the electromagnetic sensor can be changed when the chassis enters the contact patch and when exists the contact patch as a result of changing a distance between the electromagnetic sensor to the steel mesh; wherein said data transmitting unit is designed to transmit to the processing unit signal as to the changes of the intensity of the magnetic field; wherein the processing unit is designed to calculate the length of the contact patch based on said changes of the intensity of the magnetic field of the electromagnetic sensor; and wherein the calculated length of the patch can be used for calculating a load on the tire, and a time difference between entries or exits of the chassis into or from the contact patch can be used for calculating a rotation rate of the wheel.

6. The system for measuring a length of a contact patch of a tire mounted on a wheel of a vehicle while the vehicle is traveling according to claim 5 wherein said power source is a battery, a rechargeable battery or an energy harvester that converts kinetic energy to electricity.

7. A system for measuring level of bendings of a tire mounted on a wheel of a vehicle comprises a chassis, a light source, a light sensor, a data transmission unit, a power source for powering the system, and a processing unit; wherein said chassis is designed to be attached to an inner side of the tire; wherein said light source, said light sensor, said data transmitting unit, and said power source are attached to the chassis in such a way that when the light source illuminates the inner side of the tire a returning so light can be detected by the light sensor and in such a way that an intensity of the returning light can be changed due to changes of level of bendings of the tire; wherein said data transmitting unit is designed to transmit to the processing unit signal as to the intensity of the light that the light sensor detects; wherein the processing unit is designed to calculate the level of the bendings of the tire based on the changes in the intensity of the light detected by the light sensor; and wherein the calculated level of the bendings can be used for calculating a load on the tire, a rotation rate of the wheel, a road roughness, a tire alignment and a wear condition of the tire.

8. The system for measuring bendings of a tire mounted on a wheel of a vehicle according to claim 7, wherein said power source is a battery, a rechargeable battery or an energy harvester that converts kinetic energy to electricity.

9. A system for measuring bendings of a tire mounted on a wheel of a vehicle that comprises a chassis, a magnet, a magnetic field sensor, a data transmission unit, a power source for powering the system, and a processing unit; wherein the magnetic field sensor is designed to be attached to a first spot relative to the magnet, on an inner side of the tire and the magnet is designed to be attached to a second spot on the inner side of the tire, in such a way that a magnetic field of the magnet can be detected by the magnetic field sensor such that an intensity of the detected magnetic field can be changed due to bendings of the tire; wherein said data transmitting unit is designed to transmit to the processing unit signal as to the intensity of the magnetic field that the magnetic field sensor detects; wherein the processing unit is designed to calculate the bendings of the tire based on the changes in the intensity of the magnetic field detected by the magnetic field sensor; and wherein the calculated bendings can be used for calculating a load on the tire, a rotation rate of the wheel, a road roughness, a tire alignment and a wear condition of the tire.

10. The system for measuring bendings of a tire mounted on a wheel of a vehicle according to claim 9 wherein said power source is a battery, a rechargeable battery or an energy harvester that converts kinetic energy to electricity.

11. A system for measuring bendings of a tire that is reinforced by a steel mesh when the tire is mounted on a wheel of a vehicle comprises a chassis, an electromagnetic sensor, a data transmitting unit, a power source for powering the system, and a processing unit; wherein said chassis is designed to be attached to an inner side of the tire; wherein said electromagnetic sensor is attached to the chassis in such a way that an intensity of a magnetic field at the electromagnetic sensor can be changed due the bendings of the tire as a result of a change in a distance between the electromagnetic sensor to the steel mesh; wherein said data transmitting unit is designed to transmit to the processing unit signal as to the intensity of the magnetic field that the electromagnetic sensor detects; wherein the processing unit is designed to calculate the bendings of the tire based on said changes of the intensity of the magnetic field of the electromagnetic sensor; and wherein the calculated bendings of the tire can be used for calculating a load on the tire, a rotation rate of the wheel, a road roughness, a tire alignment and a wear condition of the tire.

12. The system for measuring bendings of a tire mounted on a wheel of a vehicle according to claim 11 wherein said power source is a battery, a rechargeable battery or an energy harvester that converts kinetic energy to electricity.

13. A method for calculating a load on a tire that is mounted on a wheel of a vehicle, for calculating a rotation rate of the wheel, for calculating a wear condition of the wheel, for calculating a road roughness on which the vehicle is traveling, or for calculating alignment of the tire, comprising the steps of measuring changes in bendings of the tire and using information as to said changes for processing the calculation.
